(19) United States
(12) Patent Application Publication
(10) Pub. No.: US 2021/0354274 A1
(43) Pub. Date: Nov. 18, 2021

(54) Railway Clip Positioning, Setting, and Insertion System

(71) Applicant: Focused Technology Solutions, Inc., Hackettstown, NJ (US)

(72) Inventors: Corey DASH, Mount Arlington, NJ (US); Peter M. BARTEK, Ledgewood, NJ (US); Justin McDONOUGH, Flemington, NJ (US); Mark FOYIL, Hillsborough, NJ (US); Paul LYDICK, Flemington, NJ (US)

(73) Assignee: Focused Technology Solutions, Inc., Hackettstown, NJ (US)

(21) Appl. No.: 17/320,058

(22) Filed: May 13, 2021

Related U.S. Application Data
(60) Provisional application No. 63/024,087, filed on May 13, 2020.

(51) Int. Cl. B25B 27/14; E01B 9/48; E01B 29/32; B25H 1/00

(52) U.S. Cl. CPC B25B 27/146; B25H 1/0021; E01B 29/32; E01B 9/483

(57) ABSTRACT

A clip insertion system is disclosed inserting and/or removing clips from rail plates. The clip insertion system described herein may comprise a hand tool that positions and inserts a clip into a rail plate that is attached to the railroad tie. The clip secures the steel rail to the tie. This invention represents a significant improvement over existing clip setting hand tools by improving useability, reducing safety risks, and increasing efficiency in the process/method of securing the rail using clips and/or other clip-based technologies. This system also provides and improved method of moving and positioning the tool as it is moved to successive clip insertion locations.

### RELATED APPLICATIONS

This application claims priority to U.S. Provisional Patent Application No. 63/024,087, filed May 13, 2020, the content of which is incorporated herein by reference in its entirety.

### FIELD OF THE INVENTION

The present invention relates to the railway industry and, more particularly, to a railway clip positioning, setting, and insertion system.

### BACKGROUND OF THE INVENTION

The current systems and methods for manually inserting clips by a worker requires numerous steps and motions, resulting in both injuries and inherent inefficiencies. As shown in FIGS. 1A and 1B, current methods first require a worker to set a clip 10 into the start of a hole on a rail plate 12. Then, using a sledge hammer, the worker must aim and impact the clip 10 with a sledge hammer to set the clip 10 in place. Alternatively, a hydraulically powered device can be used after a clip has been manually set by the worker. However, the currently available devices require the same worker, or another worker, to lift and position the hydraulic tool into a proper position and then actuate the hydraulic tool to push the clip into place via a hydraulic cylinder and pusher assembly.

The current systems and methods have failed to address these problems as the current systems and methods either leverage existing general-purpose tools or build on inferior technology. Some of these general-purpose tools, such as the sledge hammer, were not designed specifically for this process, are inherently unsafe, and provide a significant room for error or misuse. Other inferior technology used in these systems and methods, such as the clips and pan puller, requires significant manual effort. Often these techniques result in occupational health and safety risks due to sprung steel clips becoming dangerous projectiles when freed suddenly. Other commercially available powered tools used to position, set, and insert clips in railways leverage outdated technology that has been used in the rail industry for decades. For example, prior art hydraulic clip tools are very cumbersome and heavy, making it difficult to set the clip and move and position the tool in a useable and error-free manner. The successful operation of these prior art hydraulic tools is dependent upon operator skill through the alignment of the head with the clips. Examples of these prior art tools are illustrated in FIGS. 2A-2D. For example, FIG. 2A depicts an example prior art hydraulic power tool, FIG. 2B depicts an example prior art mechanical clip puller, and FIGS. 2C and 2D depict an example prior E-clip puller.

There is a need for an improved system and method for the positioning, setting, and insertion of railway clips that improves usability and functionality, increases efficiency, and reduces the risk of injury to the rail worker.

### SUMMARY OF THE INVENTION

Aspects of this disclosure relate to clip insertion system for inserting and/or removing clips from rail plates. The clip insertion system described herein may comprise a hand tool that positions and inserts a clip into a rail plate that is attached to the railroad tie. The clip secures the steel rail to the tie. This invention represents a significant improvement over existing clip setting hand tools by improving useability, reducing safety risks, and increasing efficiency in the process/method of securing the rail using clips and/or other clip-based technologies. This system also provides and improved method of moving and positioning the tool as it is moved to successive clip insertion locations.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1A and FIG. 1B illustrate a clip and a clip inserted into a rail plate hole;

FIGS. 2A-2D illustrate examples of prior art tools used in conventional systems and methods for inserting clips into rail plates and/or removing clips from rail plates;

FIG. 3 depicts a perspective view of an example clip insertion system, according to one or more aspects described herein;

FIG. 4A depicts a front view of an example clip insertion system, according to one or more aspects described herein;

FIG. 4B depicts a side view of an example clip insertion system, according to one or more aspects described herein;

FIG. 4C depicts a top view of an example clip insertion system, according to one or more aspects described herein;

FIG. 4D depicts a rear view of an example clip insertion system, according to one or more aspects described herein;

FIG. 4E depicts an electric power/impact wrench and screw of an example clip insertion system, according to one or more aspects described herein;

FIG. 5A and FIG. 5B depict movement of a clip, clip pusher, and screw within an example clip insertion system, according to one or more aspects described herein;

FIGS. 6A-6D depict a clip placement chute of an example clip insertion system and movement of a clip within the clip placement chute, according to one or more aspects described herein;

FIG. 7A and FIG. 7B depict a set of positioning guide of an example clip insertion system, according to one or more aspects described herein;

FIGS. 8A-8D depict an example clip insertion system comprising a mechanical-powered pusher/end effector, according to one or more aspects described herein;

FIGS. 9A-9D depict movement of a pusher and/or end effector of the example clip insertion system of FIGS. 8A-8D to insert a clip into a rail plate, according to one or more aspects described herein;

FIGS. 10A-10F depict a method of feeding and positioning clips from a cartridge-based delivery system of the example clip insertion system of FIGS. 8A-8D, according to one or more aspects described herein;

FIGS. 11A-11C depict a clip inserter positioning/registration system of an example clip insertion system, according to one or more aspects described herein;

FIGS. 12A-12D depict example positioning and orientation of the clip inserter positioning/registration system of FIGS. 11A-11C, according to one or more aspects described herein;

FIG. 13A and FIG. 13B depict an example clip insertion system, according to one or more aspects described herein;

FIGS. 14A-14D depict the progression of a clip in the example clip insertion system of FIG. 13A and FIG. 13B, according to one or more aspects described herein;

FIGS. 15A-15F depict additional views of the example clip insertion system of FIG. 13A and FIG. 13B, according to one or more aspects described herein.

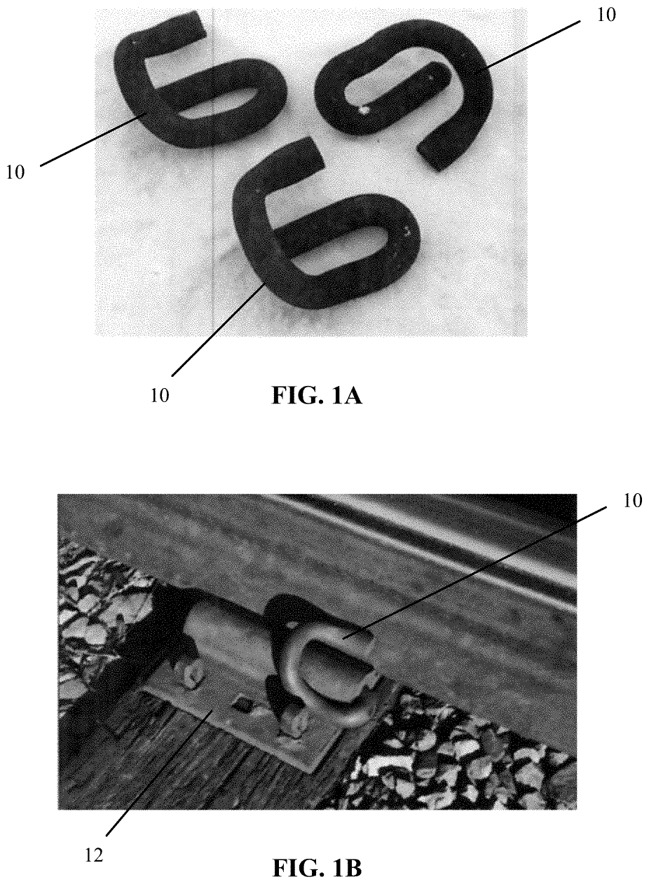

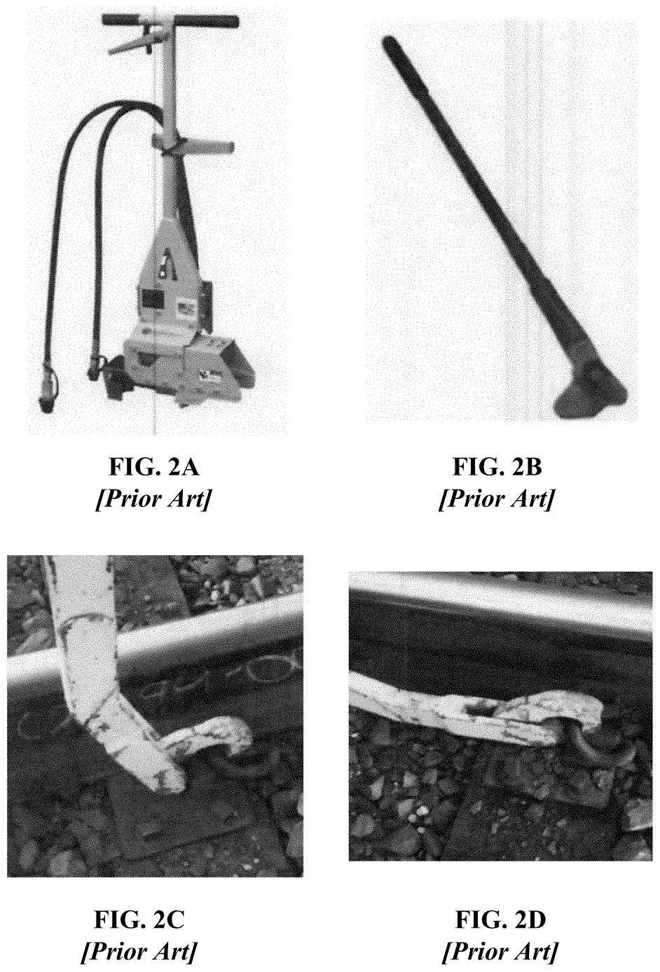

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION OF THE INVENTION

In the following description of various examples of the invention, reference is made to the accompanying drawings, which form a part hereof, and in which are shown by way of illustration various example parts, structures, systems, and steps in which aspects of the invention may be practiced. It is to be understood that other specific arrangements of example parts, structures, systems, and steps may be utilized, and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

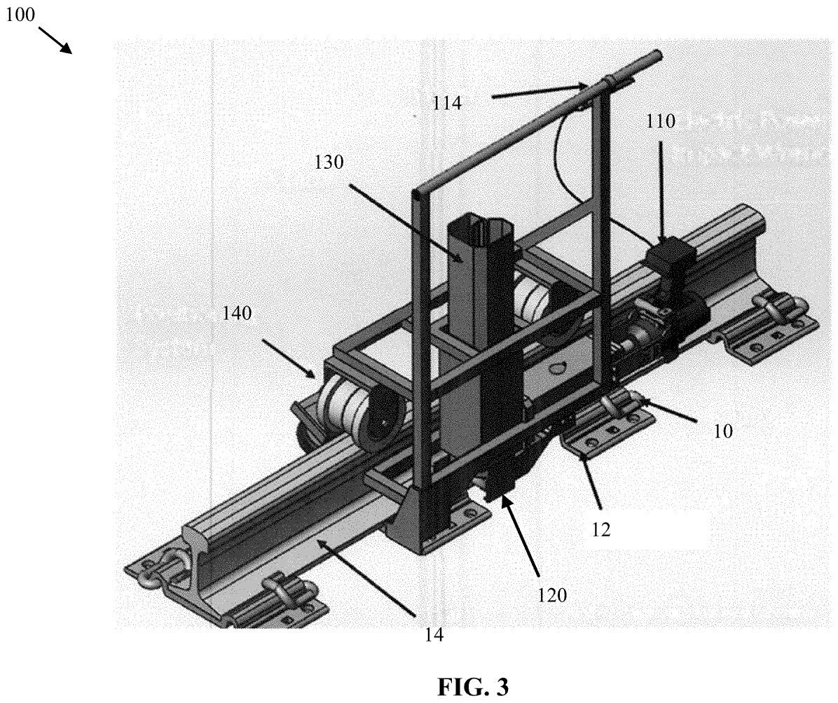

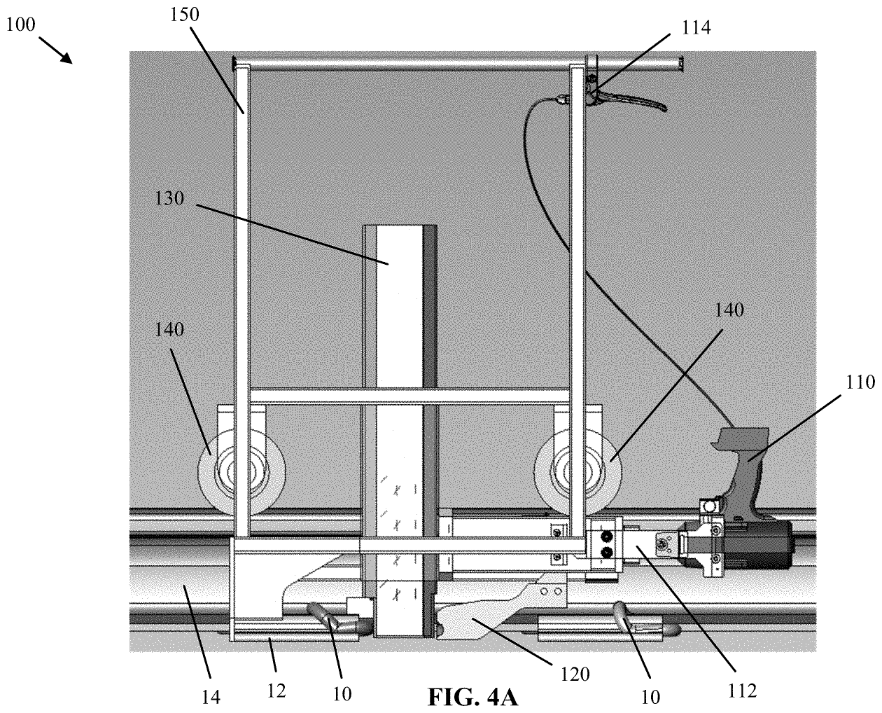

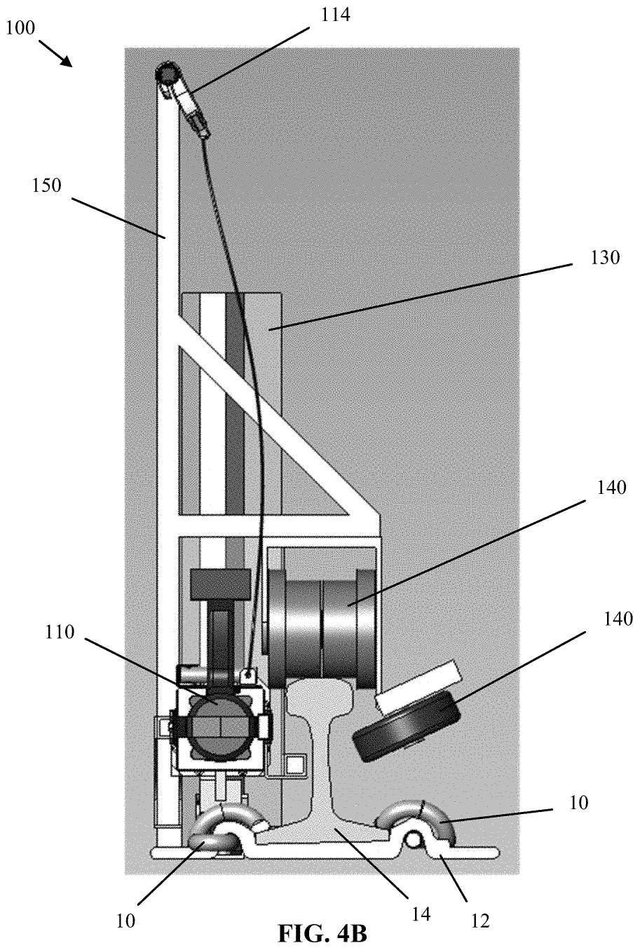

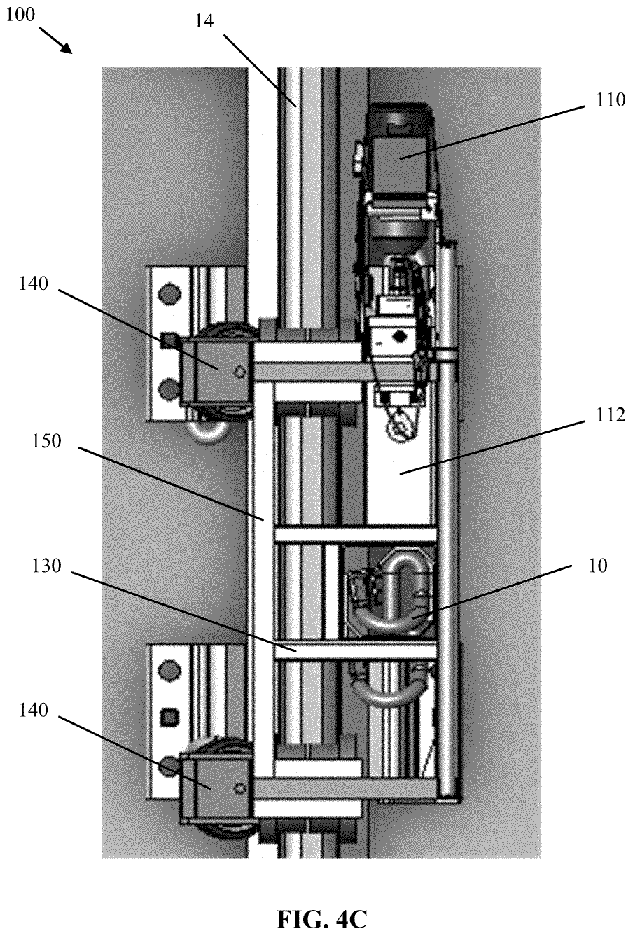

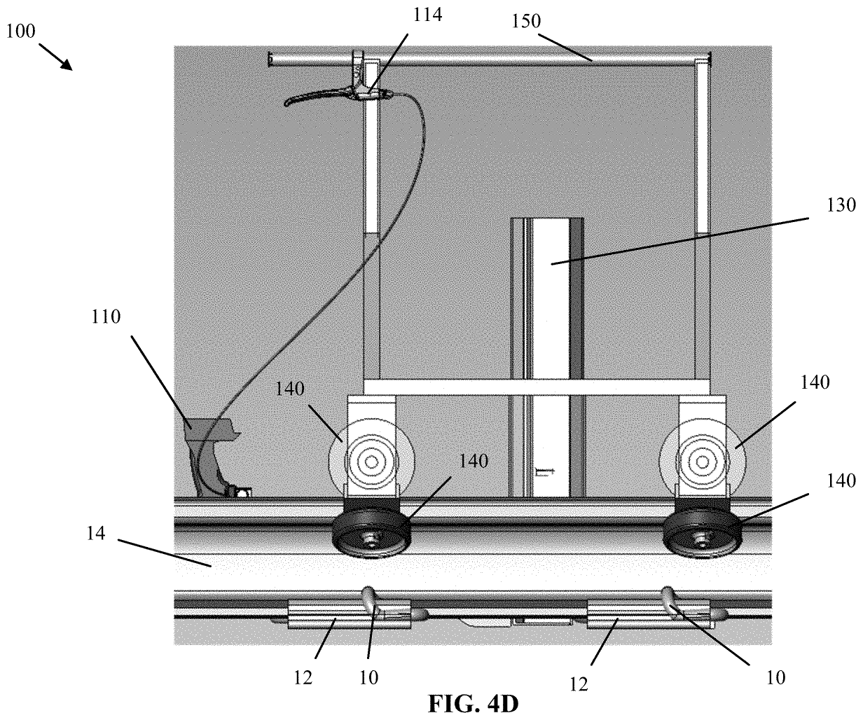

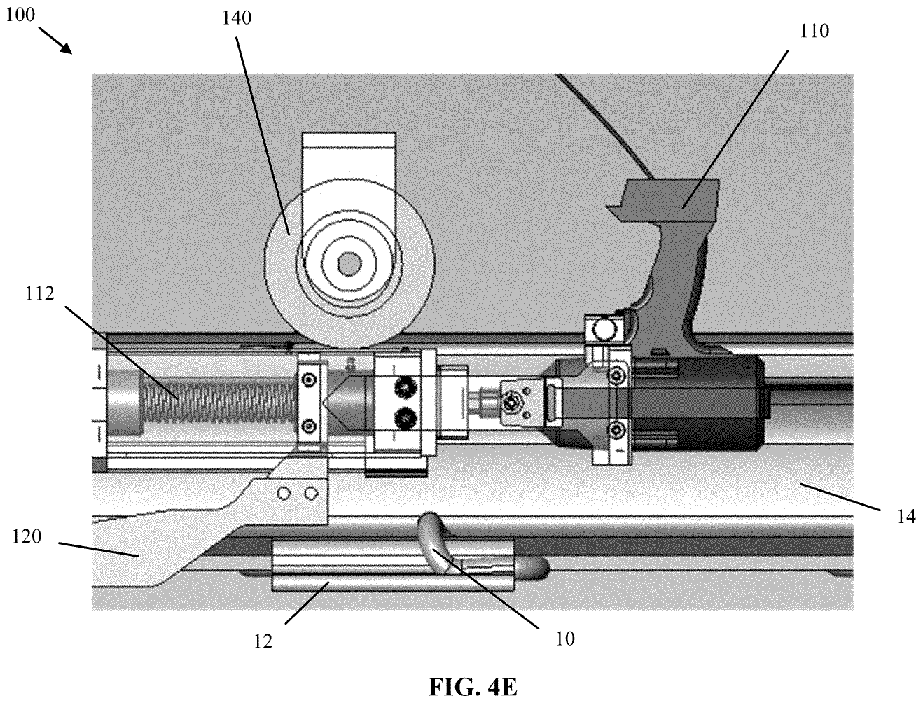

FIG. 3 and FIGS. 4A-4E depict an example clip insertion system 100 configured to position, set, and insert a clip 10 into a rail plate 12 of a rail 14, according to one or more aspects described herein. Specifically, FIG. 3 depicts a perspective view of clip insertion system 100, FIG. 4A depicts a front view of clip insertion system 100, FIG. 4B depicts a side view of clip insertion system 100, FIG. 4C depicts a top view of clip insertion system 100, FIG. 4D depicts a rear view of clip insertion system 100, and FIG. 4E depicts a close-up view of electric power/impact wrench 110 and screw 112 of clip insertion system 100. As illustrated in FIG. 3 and FIGS. 4A-4E, clip insertion system 100 may include an electric power/impact wrench 110, a screw 112, a trigger 114, a clip pusher 120, a clip placement chute 130, a device positioning system 140, a frame 150, and/or one or more other components. In various embodiments, clip insertion system 100 may include an enclosure/housing configured to protect one or more components of clip insertion system 100. The enclosure/housing is not depicted in one or more of the Figures to allow greater visibility of various components of clip insertion system 100.

In various embodiments, clip insertion system 100 may be electrically powered. For example, clip insertion system 100 may be configured to utilize a rechargeable battery and/or electric motor provided by a high-torque commercial impact drill (or electric power/impact wrench 110) coupled to the device assembly, enabling clip insertion system 100 to set a location of a clip 10 and press a clip 10 into a rail plate 12, effectively and safely securing the rail 14 to the plate/railroad tie. In various embodiments, electric power/impact wrench 110 may be directly connected to screw 112 in order to convert rotary motion to linear motion that may drive clip pusher 120 as described further below. In various embodiments, electric motor/impact wrench 110 may be configured to be initiated by trigger 114, which allows a user to control movement of clip pusher 120 in a forward or reverse direction. In various embodiments, trigger 114 may be attached to and connected to frame 150.

In various embodiments, electric power/impact wrench 110 may comprise a drill. In some embodiments, electric power/impact wrench 110 may comprise a replaceable and removable drill. In some embodiments, the drill may include a handle that may be used instead of trigger 14. For example, a drill may be used to provide power to clip insertion system 110 and control movement of clip pusher 120 as described below with respect to clip insertion system 400.

In various embodiments, clip placement chute 130 may be configured to position a clip 10 for insertion without a user having to bend over and set the clip manually. In some embodiments, clip insertion system 100 may be configured to receive cartridges of clips. For example, clip placement chute 130 may be configured to receive a cartridge of clips and sequentially feed clips to be positioned and inserted at each rail plate receptable. In various embodiments, device positioning system 140 may be configured to enable clip insertion system 100 to be rolled without having to lift clip insertion system 100 to the next rail plate 12. In some embodiments, clip insertion system 100 may be configured to remove a clip 10 through either modification of the insertion end-of-train (EOT) or quick replacement of the EOT. In some embodiments, clip insertion system 100 may include means to easily position and align clip insertion system 100 with a rail plate clip receptable.

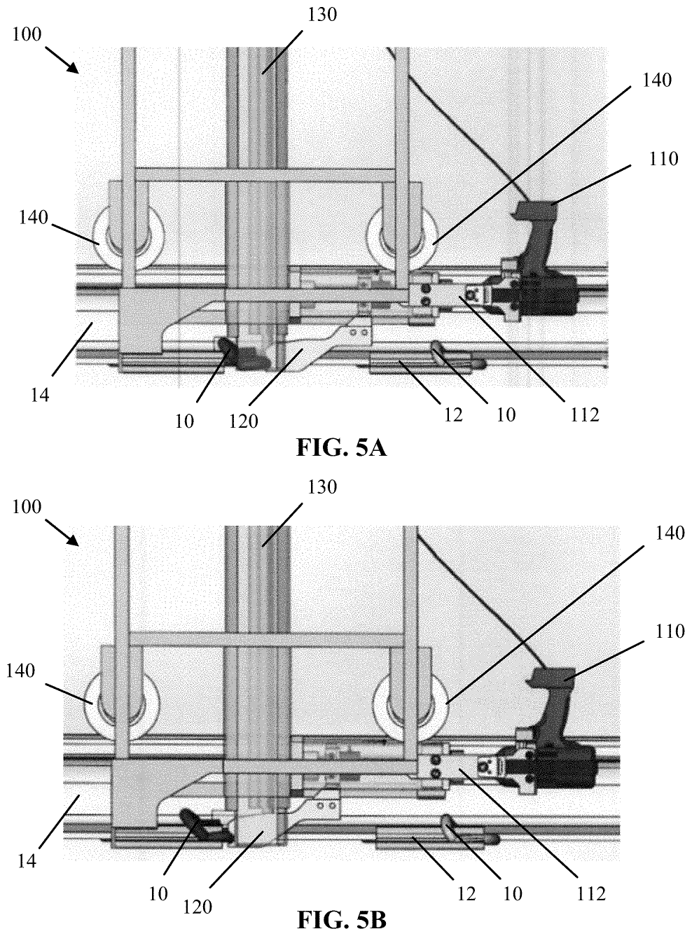

FIG. 5A and FIG. 5B depict movement of a clip 10, clip pusher 120, and screw 112 within clip insertion system 100, according to one or more aspects described herein. FIG. 5A depicts clip 10 in an insertion position within clip insertion system 100 following retraction of clip pusher 120. As illustrated in FIG. 5A, in various embodiments, clip 10 is able to drop into position following retraction of clip pusher 120. FIG. 5B depicts clip pusher 120 and clip 10 in the fully inserted position within clip insertion system 100. As illustrated in FIG. 5B, clip insertion system 100 may operate by converting the rotary motion of electric power/impact wrench 110 into linear motion via screw 112, which drives clip pusher 120 and causes clip 10 to be inserted into rail plate 12. In various embodiments, clip pusher 120 may be configured to allow clip insertion system 100 to move without dropping clip 10.

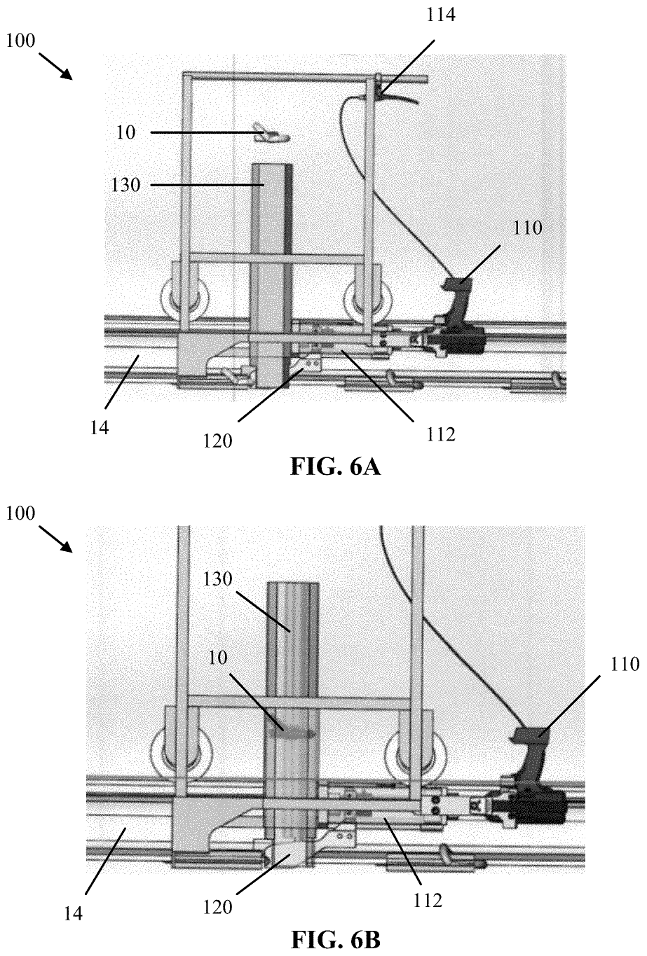

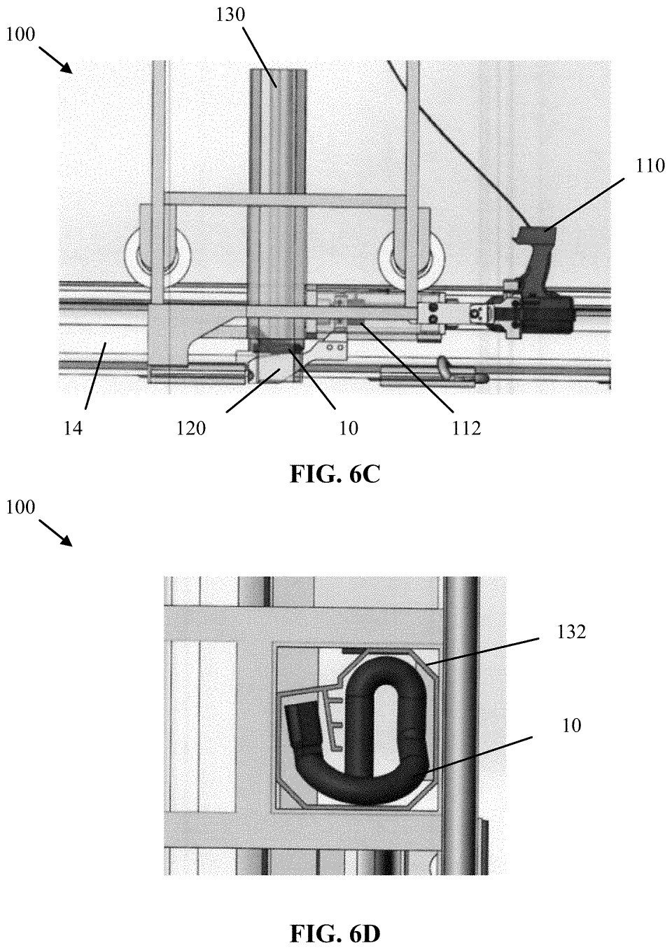

FIGS. 6A-6D depict clip placement chute 130 of clip insertion system 100 and how clip 10 moves within clip placement chute 130, according to one or more aspects described herein. In various embodiments, clip placement chute 130 may be located vertically above clip pusher 120. In various embodiments, clip placement chute 130 may be configured to allow clip 10 to be dropped and directly positioned in front of a rail plate receptacle so that it may be engaged by clip pusher 120 to set and install clip 10. FIG. 6A depicts a clip 10 located above a top end of clip placement chute 130 prior to clip 10 being dropped into clip placement chute 130. FIG. 6B depicts a clip 10 located within clip placement chute 130 after clip 10 has been dropped into clip placement chute 130 but prior to clip 10 reaching the bottom end of clip placement chute. FIG. 6C depicts a clip 10 located at a bottom end of clip placement chute 130 after clip 10 has been dropped into clip placement chute 130, traveled through clip placement chute 130, and reached clip pusher 120 located proximate the bottom end of clip placement chute 130. In various embodiments, clip placement chute 130 may be configured to guide clip 10 while clip 10 travels within clip placement chute 130. For example, FIG. 6D depicts a top view of clip placement chute 130 with a chute guiding control surface 132 configured to guide clip 10 while clip 10 travels downward within clip placement chute 130. In various embodiments, chute guiding control surface 132 may comprise one or more internal walls within chip placement chute 130 that are configured to receive and guide a specific type of clip 10 down chip placement chute 130. For example, as illustrated in FIG. 6D, chute guiding control surface 132 may be specifically configured to receive and guide an E-clip type clip.

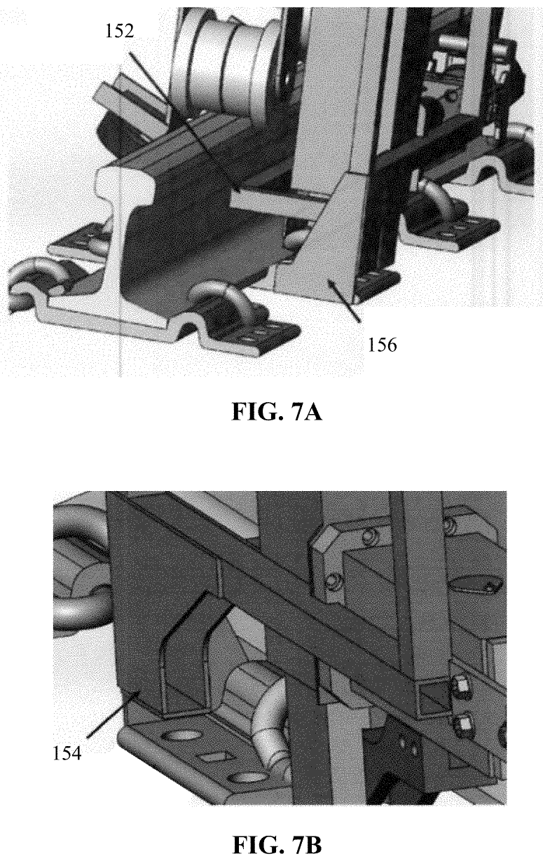

FIG. 7A and FIG. 7B depict a set of positioning guide of an example clip insertion system, according to one or more aspects described herein. In various embodiments, device positioning system 140 may be configured to ride on rail 14 and allow clip insertion system 100 to be easily moved and positioned over the next rail plate 12 for installation of a clip 10. The device positioning system 140 may be configured to significantly reduce the required force to move clip insertion system 100, improve handling and efficiency, and reduce the risk of injury to the operator. In various embodiments, clip insertion system 100 may be configured to position clip 10 for insertion in a receptable of rail plate 12. Aligning clip 10 with the rail plate 12 receptacle may be done in a number of ways in the X, Y, and Z direction based off the rail plate 12 or stationary rail 14. In some embodiments, change parts or internal adjustment mechanisms known in the art (set screws/stops, change parts, etc.) may be utilized to adjust to different types of rail plates 12 and rails 14. In various embodiments, clip insertion system 100 may be properly positioned utilizing a set of positioning guides to properly align the clip insertion system 100 and the next clip 10 for insertion into the rail plate 14. In various embodiments, the set of positioning guides may include an X-positioning guide 152, a Y-positioning guide 154, and/or a Z-positioning guide 156. In various embodiments, the positioning guides may be configured to key off rail plate 12 and/or rail 14. For example, FIG. 7A depicts a X-positioning guide 152 utilized off the rail and a Z-positioning guide 156 utilized off the rail plate, and FIG. 7B depicts a Y-positioning guide 154 utilized off the rail plate and/or the rail. In some embodiments, the X, Y, and Z positioning guides may also be located off the back of the rail plate receptacle through the hole.

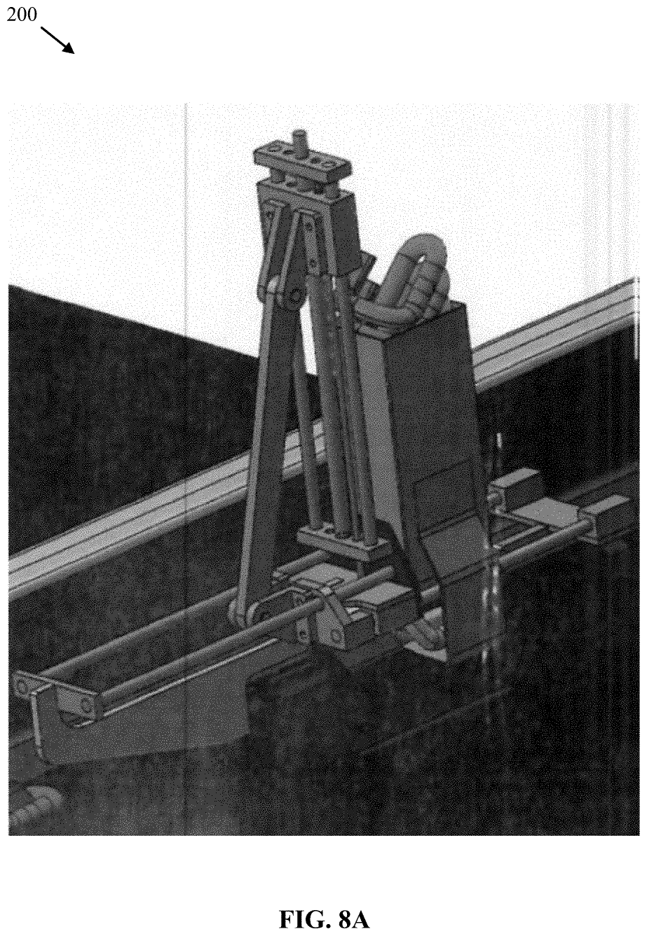

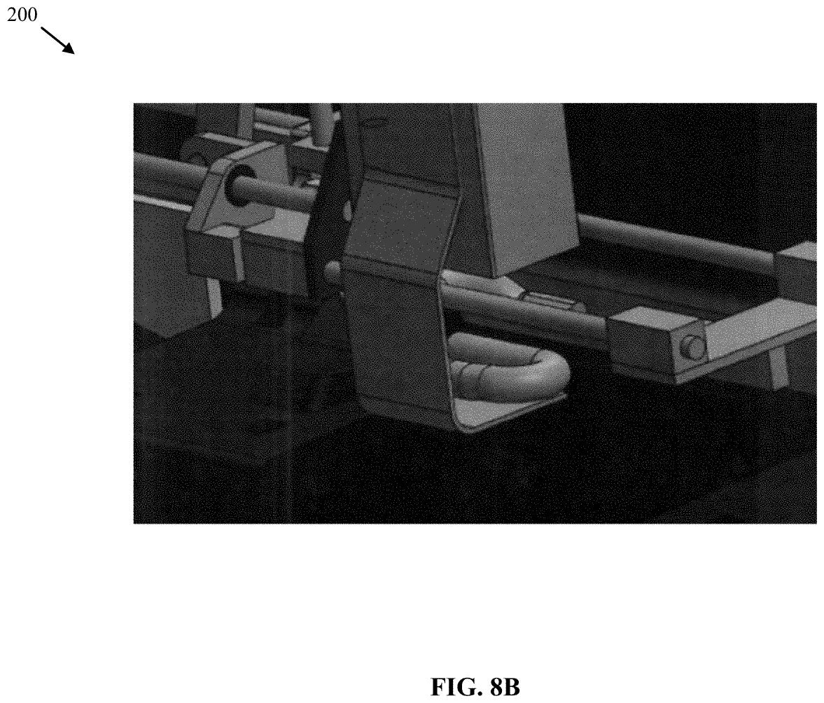

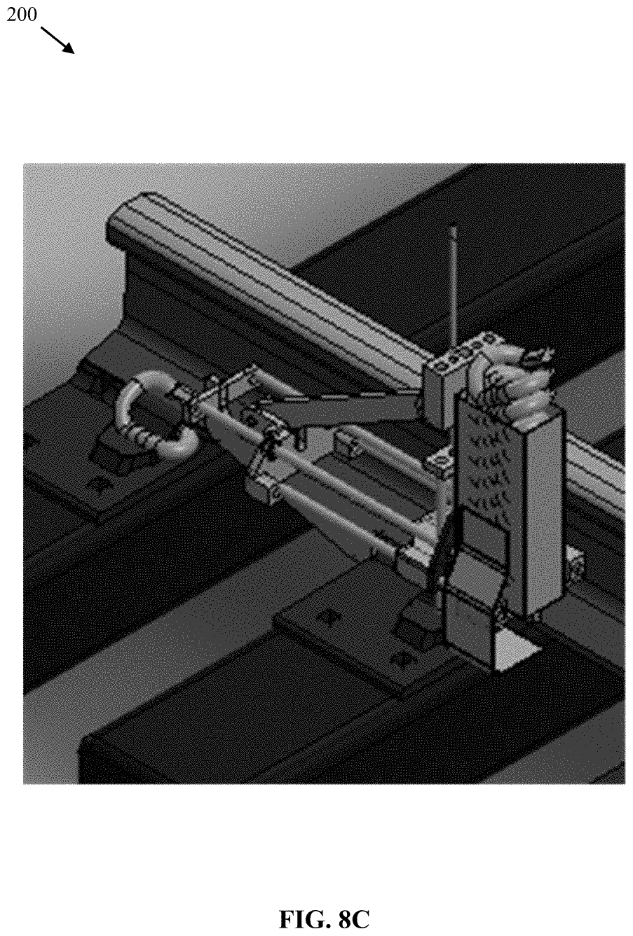

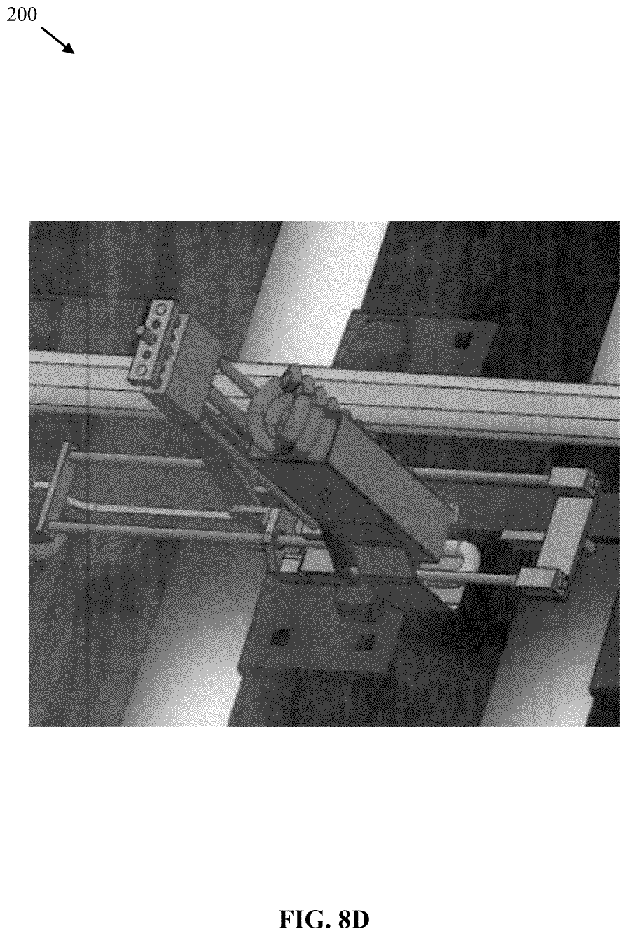

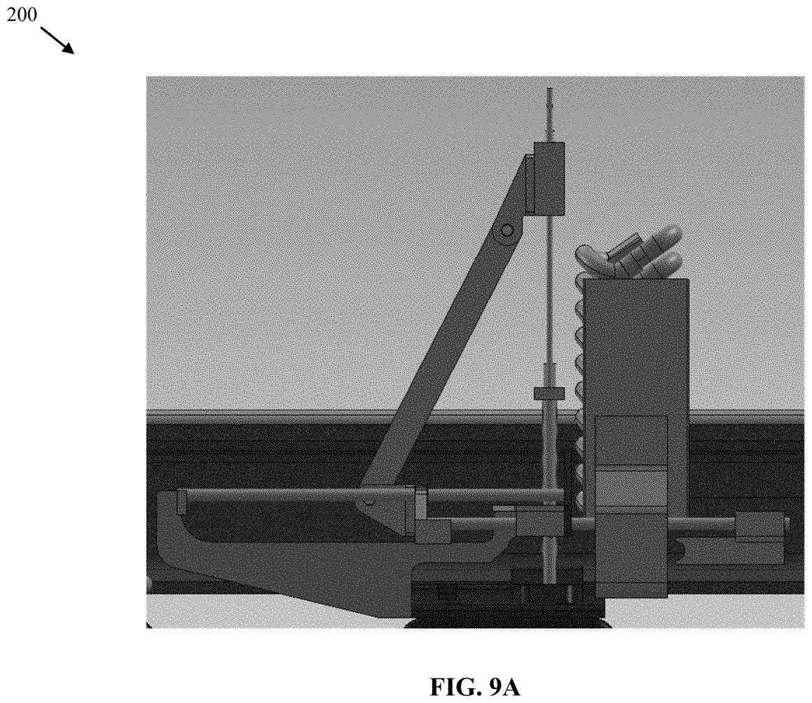

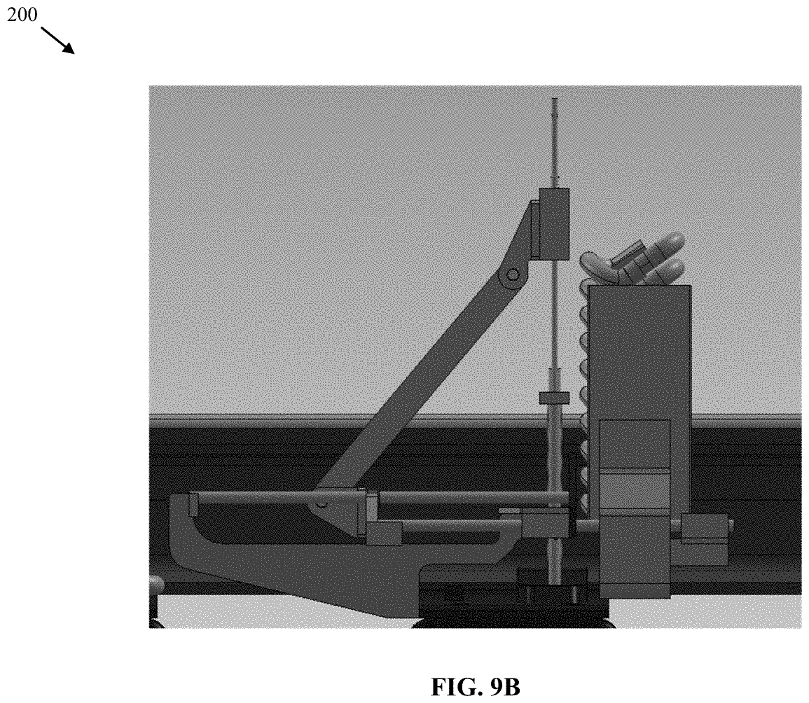

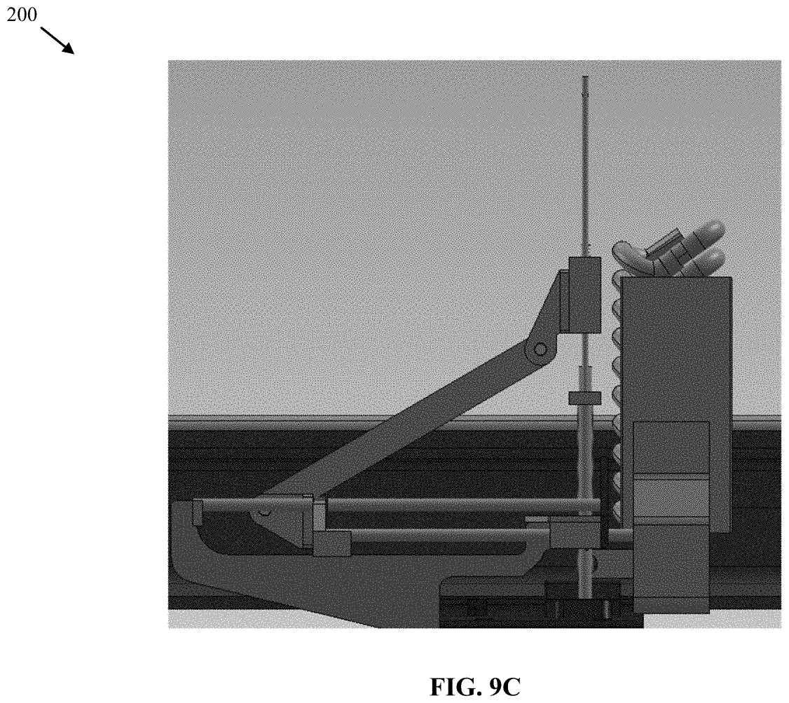

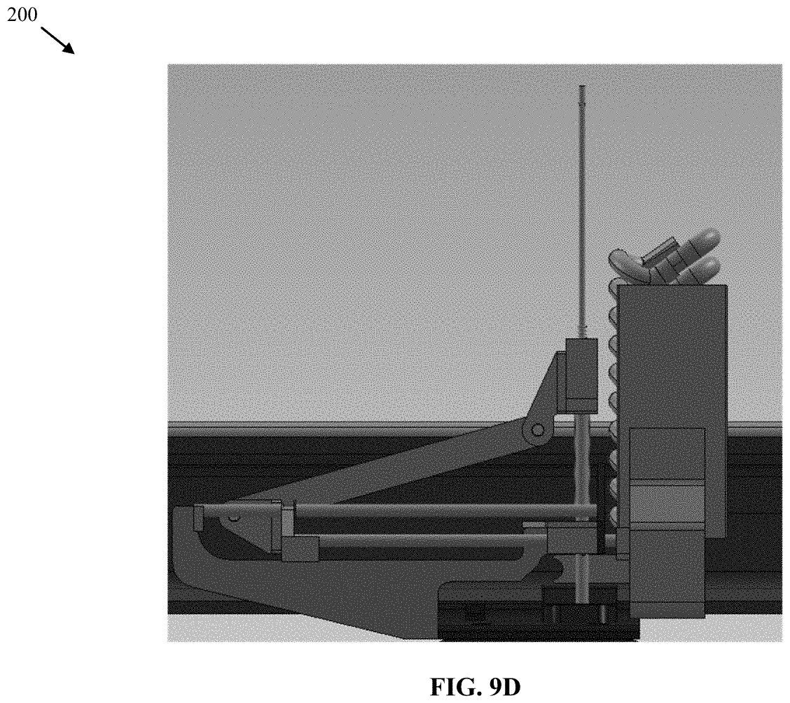

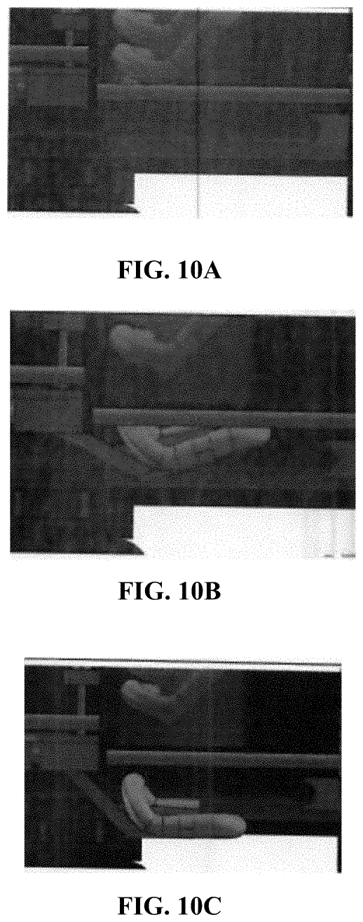

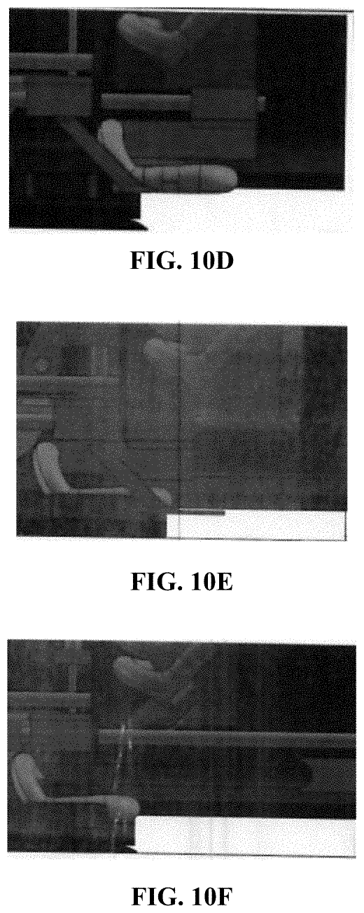

In some embodiments, instead of being electrically powered (e.g., by a rechargeable battery and/or electric motor of electric power/impact wrench 110), mechanical linear motion may be used to insert and/or remove a clip 10 from a rail plate 12. For example, FIGS. 8A-8D depict an example clip insertion system 200 comprising a mechanical-powered pusher/end effector, according to one or more aspects described herein. FIGS. 9A-9D depict movement of a pusher and/or end effector of clip insertion system 200 to insert a clip into a rail plate, according to one or more aspects described herein. For the embodiment of the clip insertion system depicted in FIGS. 8A-8D and FIGS. 9A-9D, the features are referred to using similar reference numerals under the “2xx” series of reference numerals, rather than “1xx” used in the Figures depicting clip insertion system 100. Accordingly, certain features of clip insertion system 200 that were already described above with respect to clip insertion system 100 may be shown in lesser detail, or may not be described at all. In some embodiments, clip insertion system 100 and/or clip insertion system 200 may be configured to feed clips for insertion into a rail plate using a cartridge-based delivery system. For example, FIGS. 10A-10F depict a method of feeding and positioning clips from a cartridge-based delivery system of clip insertion system 200, according to one or more aspects described herein. In some embodiments,

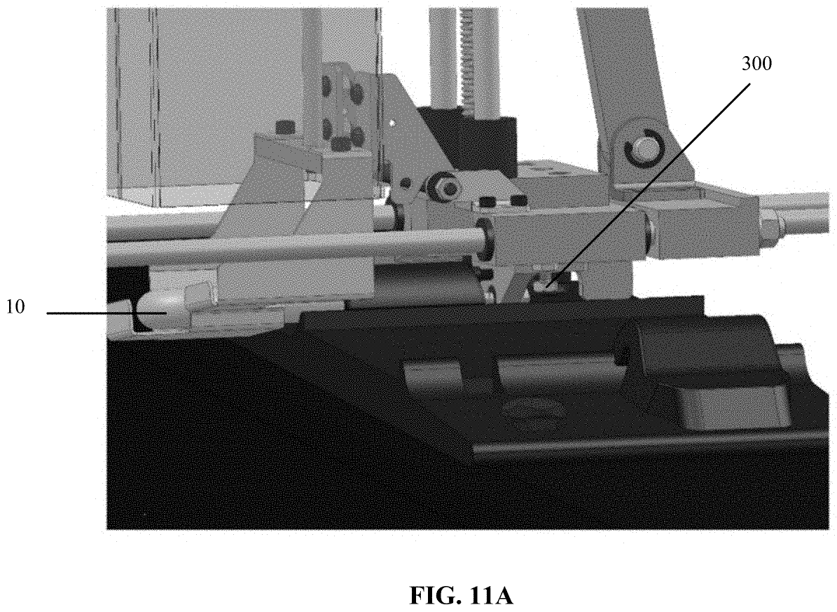

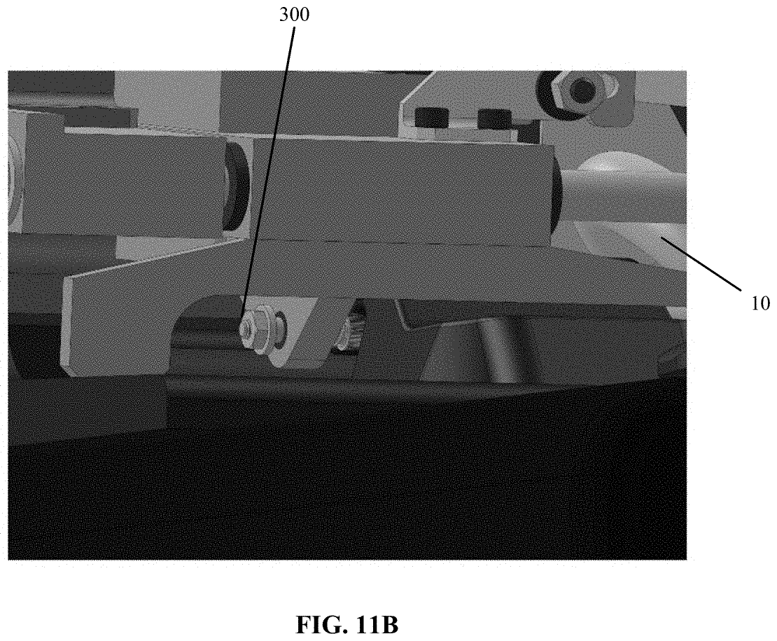

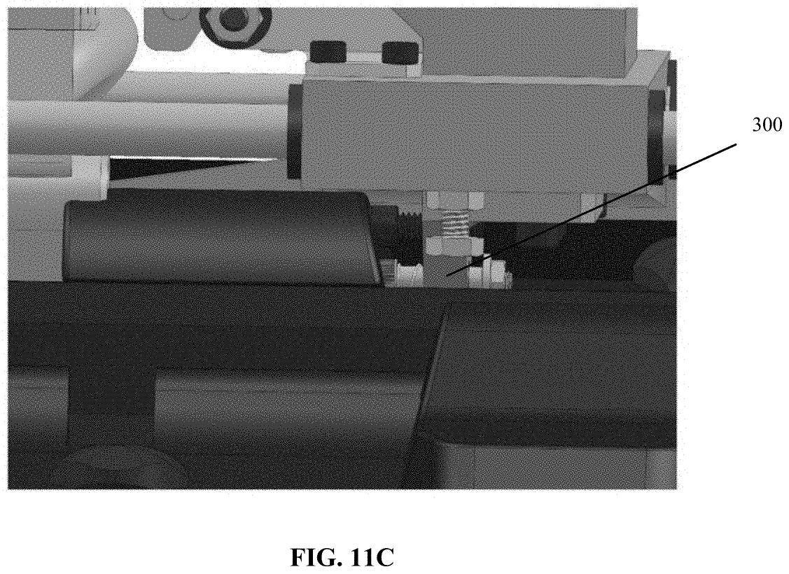

FIGS. 11A-11C depicts a clip inserter positioning/registration system 300 for use with a clip insertion system, according to one or more aspects described herein. Specifically, FIG. 11A depicts a rail-side auxiliary detail view of clip inserter positioning/registration system 300, FIG. 11B depicts a user-side auxiliary detail view of clip inserter positioning/registration system 300, and FIG. 11C depicts a rail-side auxiliary detail view of clip inserter positioning/registration system 300. In various embodiments, clip inserter positioning/registration system 300 may be configured to be used with clip insertion system 100, clip insertion system 200, and/or clip insertion system 400 described herein. As illustrated in FIGS. 11A-11C, clip inserter positioning/registration system 300 may be configured to enable registration within the clip insertion system by providing X, Y, Z, and angular positioning of the clip insertion system with respect to rail plate 12. In various embodiments, proper X, Y, Z, and/or angular positioning of the clip insertion system with respect to rail plate 12 may be required to properly position or orient the clip insertion system such that clips 10 may be inserted into plate 12. This method of registration may be configured to maintain/hold the position of the clip 10 throughout the setting and insertion process to improve safety and efficiency. It may also provide a redundant reactionary force that prevents the clip insertion system from moving during the setting and insertion process.

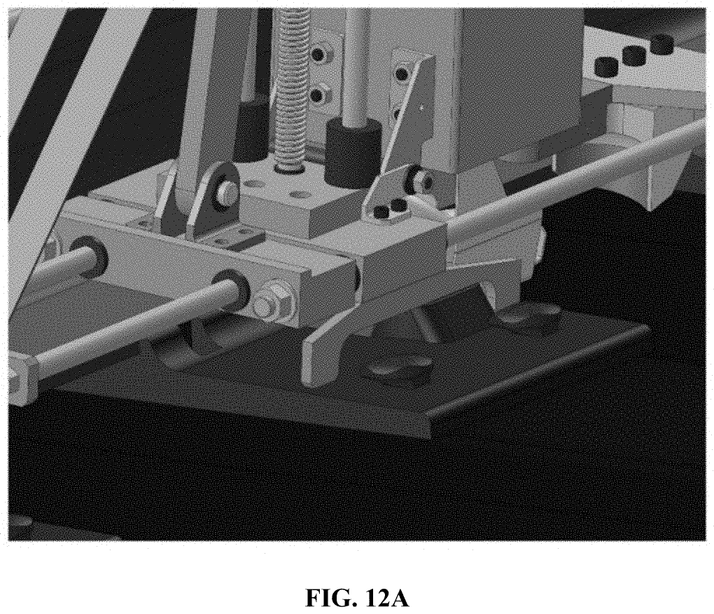

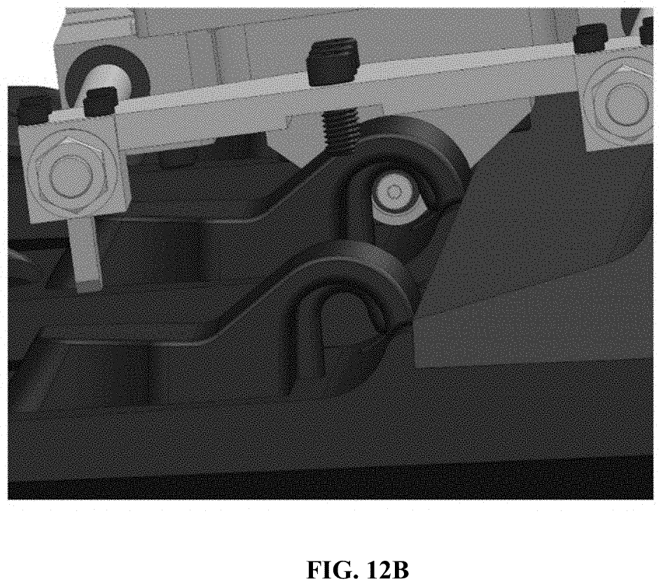

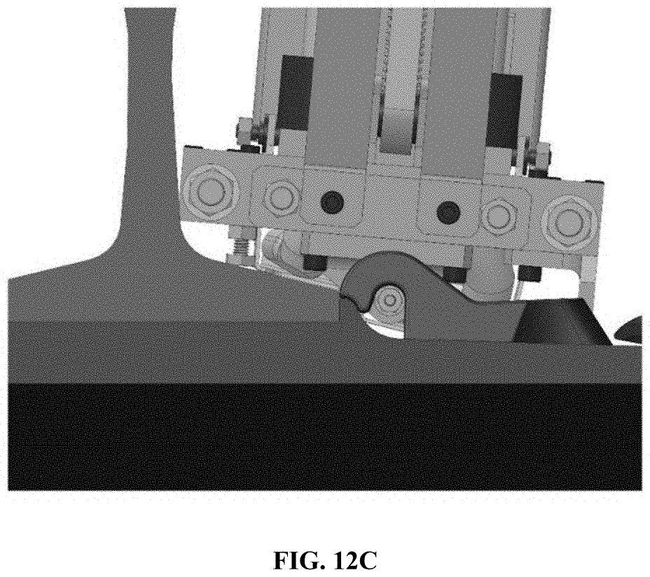

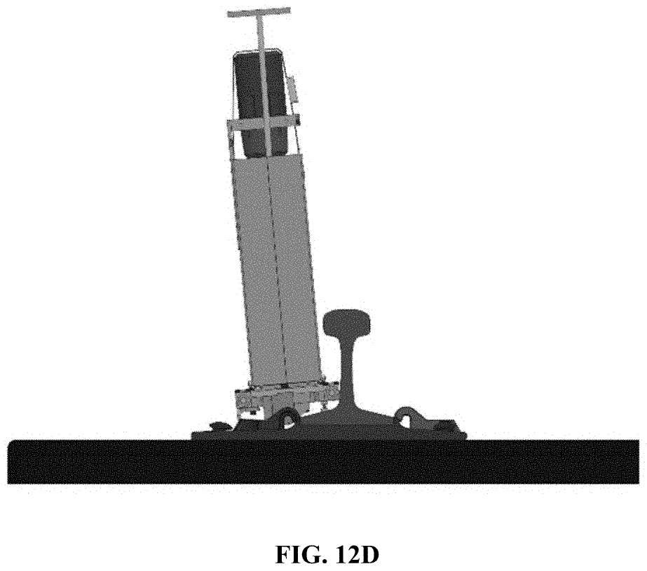

In various implementations, clip inserter positioning/registration system 300 may be configured to leverage the back of the rail plate shoulder and/or clip hole—as shown in FIGS. 11A-11C—to provide the required X, Y, Z, and/or angular positioning of the clip insertion system. In various implementations, the shaft of the location device fits concentrically into the rail plate back hole, and the sliding shaft of the positioner may be pushed back out of the registration hole by the clip 10 as it is being inserted. Resistance to the sliding motion may be provided by a compression spring as shown. FIGS. 12A-12D depict example positioning and orientation of the clip inserter positioning/registration system 300 within a clip insertion system, according to one or more aspects described herein;

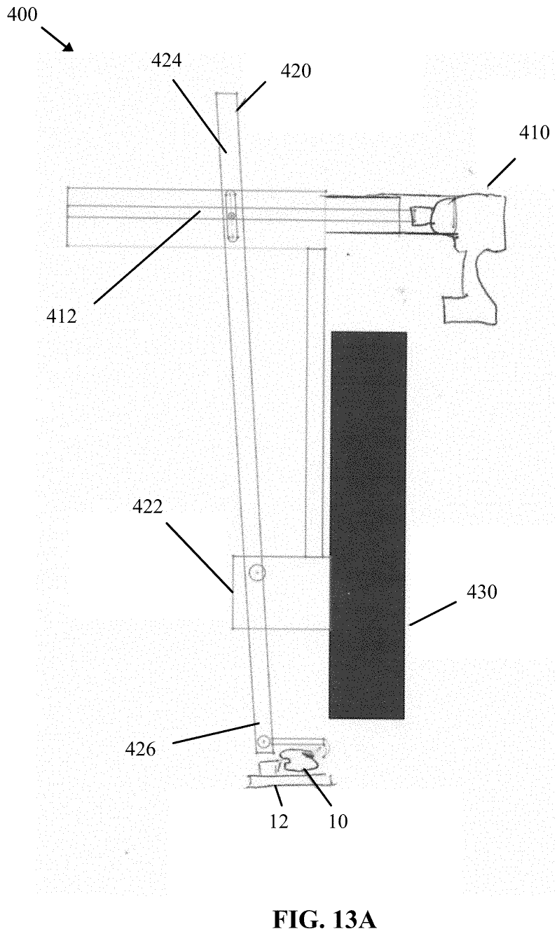

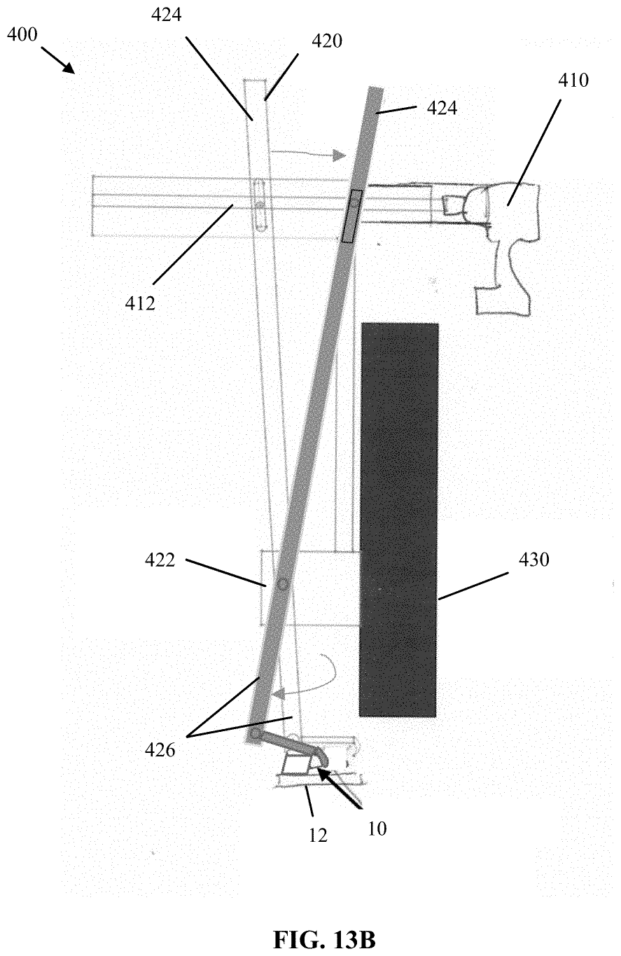

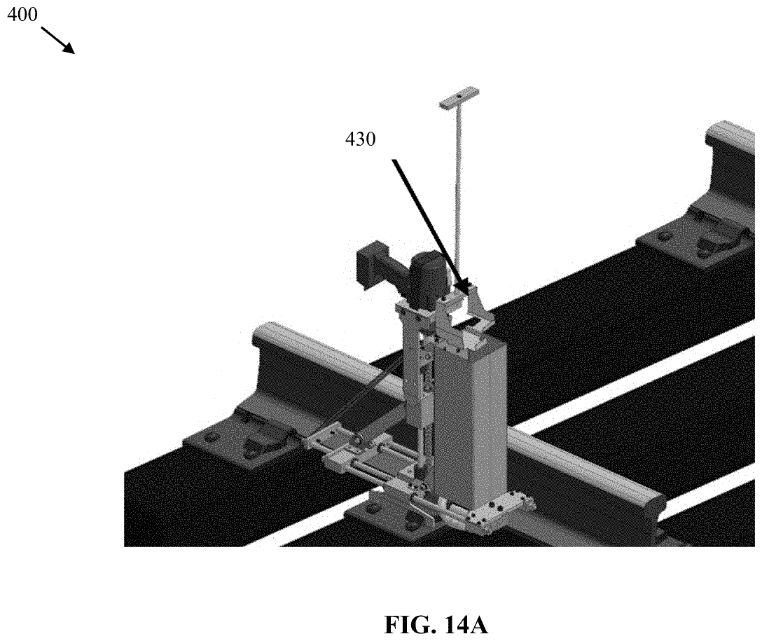

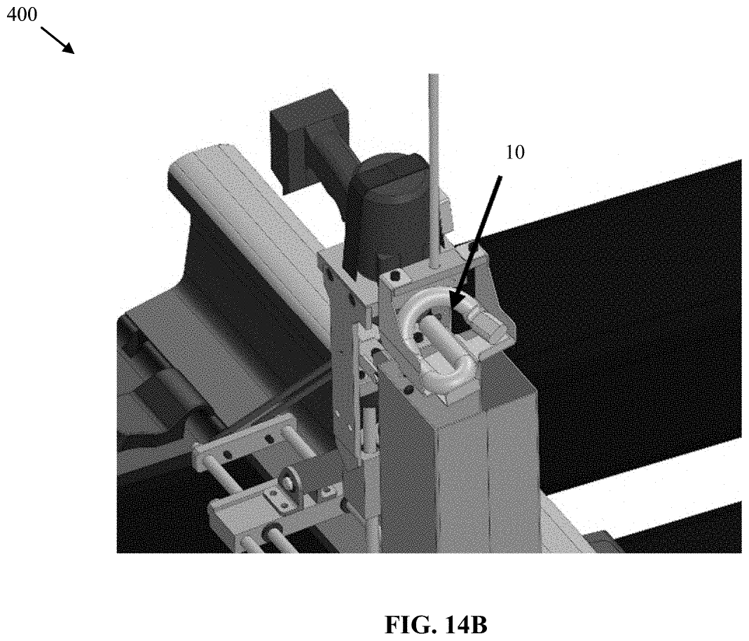

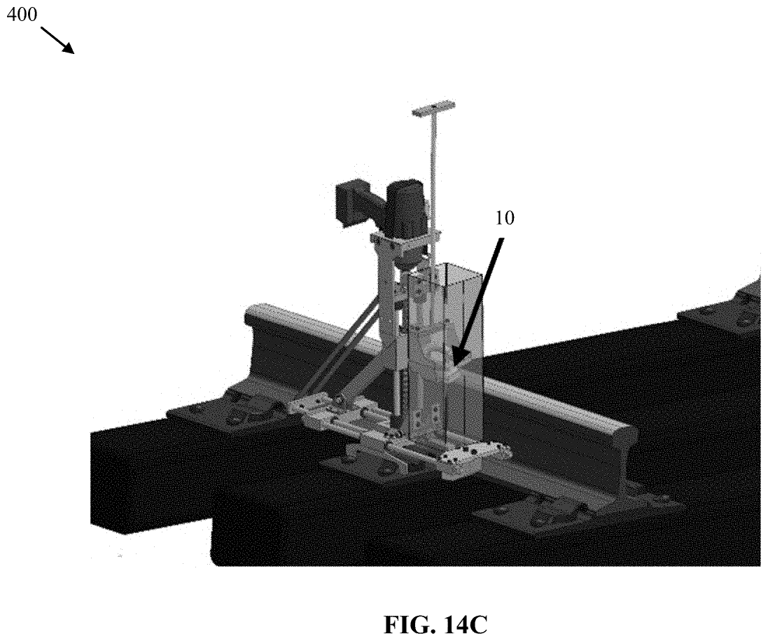

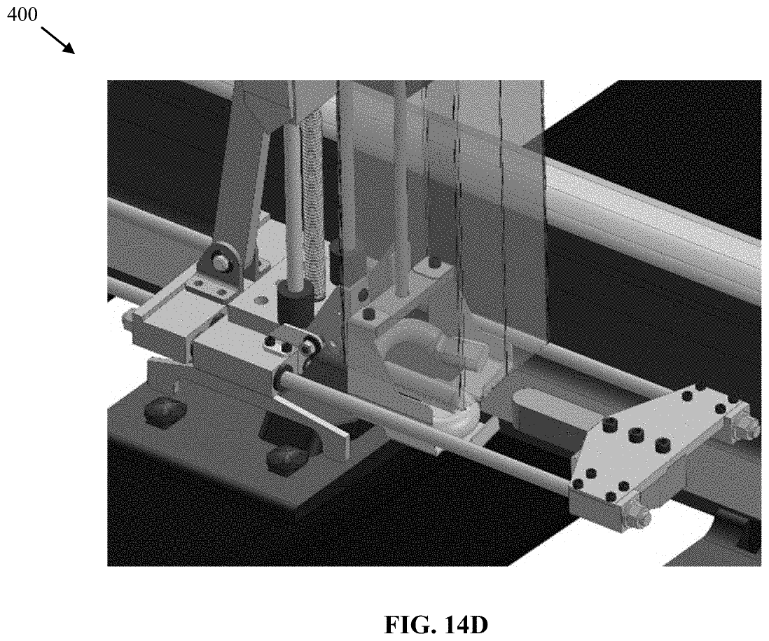

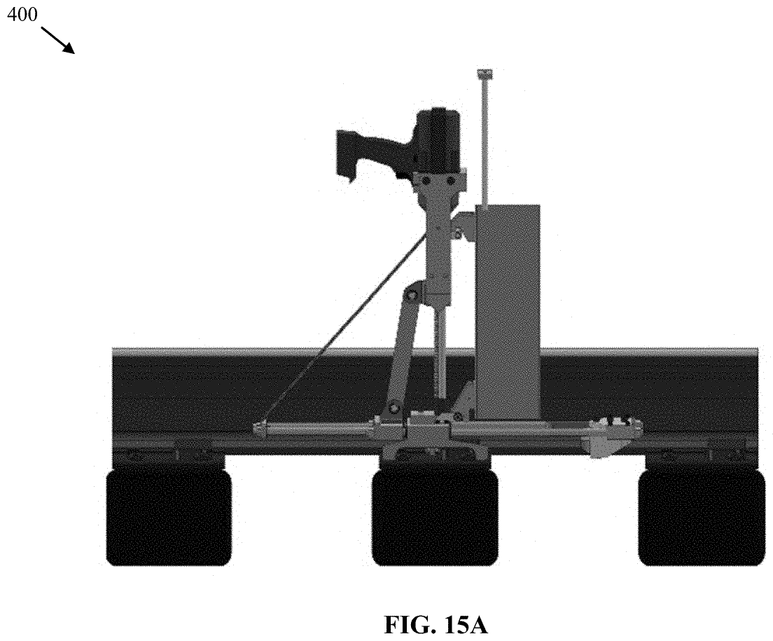

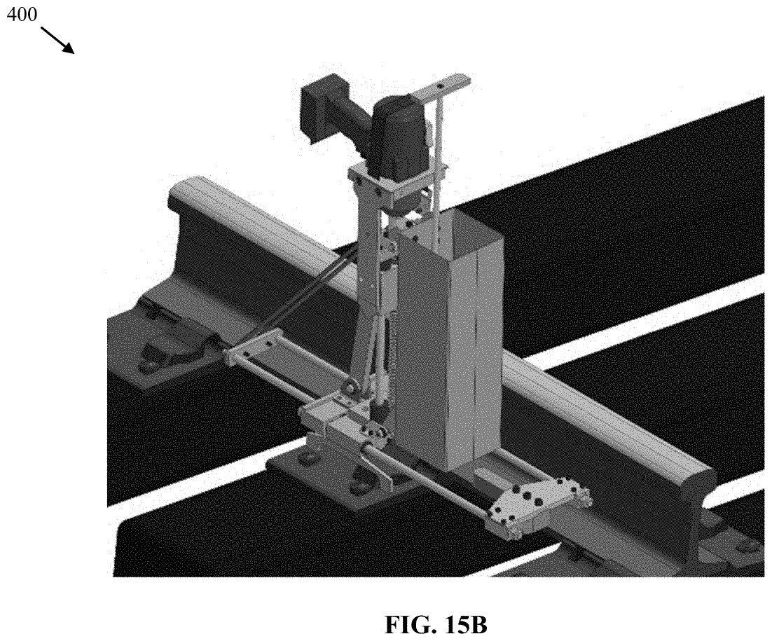

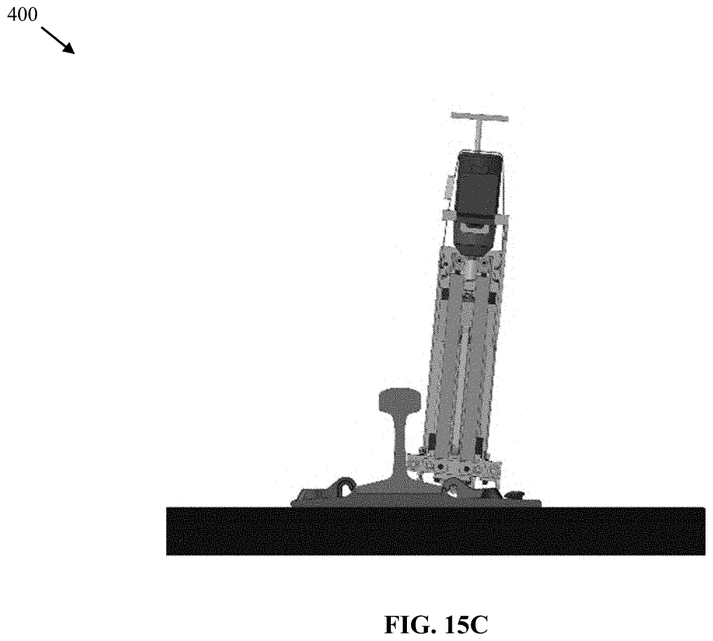

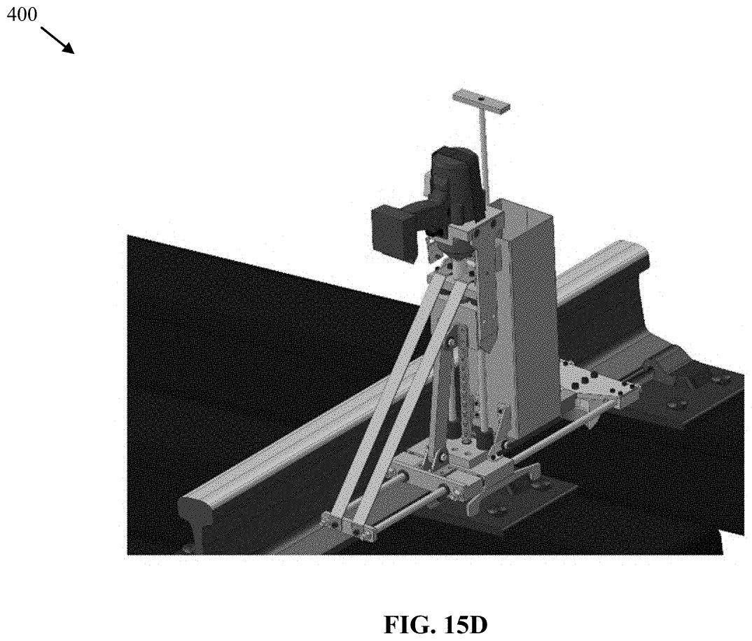

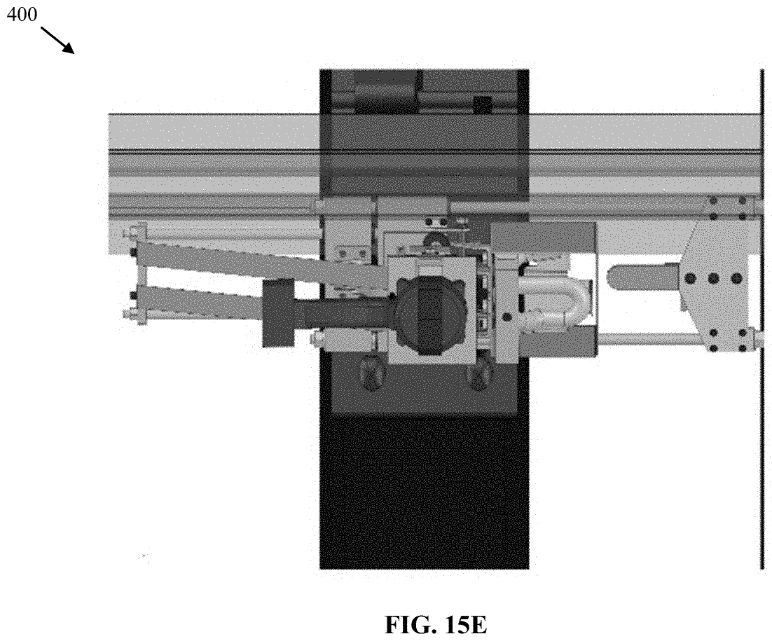

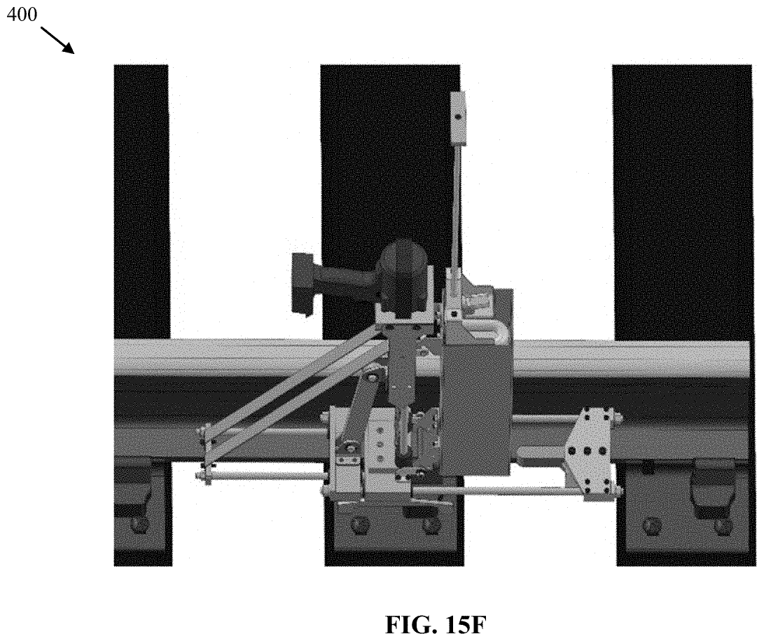

FIG. 13A and FIG. 13B depict an example clip insertion system 400 configured to position, set, and insert a clip 10 into a rail plate 12 of a rail 14, according to one or more aspects described herein. FIGS. 14A-14D depict the progression of clip 10 in clip insertion system 400, according to one or more aspects described herein. FIGS. 15A-15F depict additional views of clip insertion system 400, according to one or more aspects described herein. For the embodiment of the clip insertion system depicted in FIG. 13A and FIG. 13B, FIGS. 14A-14D, and FIGS. 15A-15F, the features are referred to using similar reference numerals under the “4xx” series of reference numerals, rather than “1xx” used in the Figures depicting clip insertion system 100. Accordingly, certain features of clip insertion system 400 that were already described above with respect to clip insertion system 100 may be shown in lesser detail, or may not be described at all.

In various embodiments, the clip insertion system described herein may comprise a hand tool configured to be portable and/or easily maneuverable by a user. For example, FIGS. 13A and 13B depict a hand tool/clip insertion system 400 that uses an electric drive motor. In some embodiments, the clip insertion systems described herein may include a commercially available electric impact wrench/drill 410 that is used to insert and/or remove clips 10 from a rail plate 12. For example, clip insertion system 400 may include an electric power/impact wrench 410 connected to or attached to a first side 424 of a leverage arm 420 with a rotating connection to a fulcrum 422. In various embodiments, leverage arm 420 may be rotationally moved about the fulcrum 422 to cause a second side 426 of the leverage arm 420 push or pull a clip 10 from the tie or rail plate 12. In various embodiments, clip insertion system 400 may include a clip placement chute 430 located vertically above the clip 10/tie plate 12. In various embodiments, clip placement chute 430 may be configured to allow clip 10 to be dropped and directly positioned in front of the rail plate receptacle and engaged by the second side 426 of the leverage arm 420 to set and install or remove the clip 10. In various embodiments, electric power/impact wrench 410 may be directly coupled to a screw 412 (as described above) so that it may convert the rotary motion to linear motion in order to linearly drive a leverage arm 420 (or clip pusher 420) as shown for insertion and/or removal of a clip 10. In various embodiments, electric motor/impact wrench 410 may be initiated by a trigger that allows a user to control the forward or reverse movement of leverage arm 420.

FIGS. 14A-14D depict clip placement chute 430 of clip insertion system 400 and how clip 10 moves within clip placement chute 430, according to one or more aspects described herein. In In various embodiments, clip placement chute 430 may be configured to allow clip 10 to be dropped and directly positioned in front of a rail plate receptacle so that it may be engaged by leverage arm 420 to set and install clip 10. FIG. 14A depicts clip insertion system 400 registered on rail plate 12 and waiting for clip 10 insertion into the clip placement chute 430. FIG. 14B depicts clip 10 placed into the clip placement chute 430 and ready to be lowered into place through clip placement chute 430. FIG. 14C depicts clip 10 located within clip placement chute 430 while being lowered into position in the bottom of the clip placement chute 430 with the clip placement chute 430 shown as translucent. FIG. 14D depicts clip 10 on the bottom (or shoe) of clip placement chute 430 and located in the insertion orientation and position in clip insertion system 400.

In various embodiments, clip insertion systems 100, 200, 400 may be configured to provide a means to allow controlled single clip 10 placement in correct position for insertion into the rail plate 12 without the user having to bend down, place, and orient the clip insertion systems 100, 200, 400. The clip 10 would then pushed under high force into the rail plate shoulder to secure the rail. The clip insertion systems 100, 200, 400 improve efficiency and safety as may be achieved by reducing the user motions required (i.e., bending over and getting close to ground to insert the clip properly), and keeping the user's hands away from potentially dangerous areas of the clip insertion systems 100, 200, 400, while also reducing the potential for misaligned clips 10 and increasing the overall speed of the insertion process. In various embodiments, clip insertion systems 100, 200, 400 with positioning systems may be configured to provide feedback to the user when in the correct position for clip 10 loading (top position) and insertion (bottom position) via audio, visual, and/or tactile means.

In various embodiments, electric power/impact wrench 110, 210, 410 may comprise an impact drill, driver, wrench, or similar tool, such as electronic, pneumatic, or other such drill-type tool configured to perform similar functionality as a battery-operated drill-type tool. In various embodiments, the drill may include a battery. In some embodiments, the battery may comprise a rechargeable battery. The battery may be configured to provide power to clip insertion systems 100, 200, 400. In some embodiments, clip insertion systems 100, 200, 400 may be powered via additional and/or alternative power means, such as via AC power, replaceable fuel cell, and/or other stored/created electric power techniques known in the art. In some embodiments, clip insertion systems 100, 200, 400 may be integrally-powered by a DC motor, servo motor, or stepper motor. In some embodiments, clip insertion systems 100, 200, 400 may be powered by a set of batteries (AC or DC) or battery packs. In some embodiments, clip insertion systems 100, 200, 400 may include or be connected to a battery management system. For example, clip insertion systems 100, 200, 400 may be powered by a set of batteries (AC or DC) or battery packs and/or include or be connected to a battery management system as described in U.S. Provisional Patent Application No. 63/092,317, entitled “BATTERY-OPERATED SPIKE DRIVER,” the disclosure of which is hereby incorporated by reference in its entirety herein.

In various embodiments, clip insertion systems 100, 200, 400 may include a handle assembly. For example, any of the clip insertion systems described herein may include a handle assembly configured to receive a electric power/impact wrench 110, 210, 410, as depicted in FIG. 13A and FIG. 13B, FIGS. 14A-14D, and FIGS. 15A-15F. In some implementations, clip insertion systems 100, 200, 400 may include a T-handle assembly and/or one or more other components the same as or similar to the components of railroad spike remover 100, 300, and 500 described in U.S. patent application Ser. No. 16/734,125, entitled “RAILROAD SPIKE REMOVER,” the disclosure of which is hereby incorporated by reference in its entirety herein.

The present disclosure is disclosed above and in the accompanying drawings with reference to a variety of examples. The purpose served by the disclosure, however, is to provide examples of the various features and concepts related to the disclosure, not to limit the scope of the invention. It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. Specifically, it should be understood that the components or features of one embodiment described herein may be combined to with one or more components or features of other embodiments described herein without departing from the scope of the invention. The embodiments described herein explain the best modes known for practicing the invention and will enable others skilled in the art to utilize the invention.

While the preferred embodiments of the invention have been shown and described, one skilled in the relevant art will recognize that numerous variations and modifications may be made to the examples described above without departing from the scope of the present disclosure. Thus, the spirit and scope of the invention should be construed broadly as set forth in the appended claims.

What is claimed is:

1. A clip insertion system for inserting clips into rail plates to secure a rail to a rail tie, the system comprising:
an electric-powered drill;
a clip placement chute configured to receive clips to be inserted into a rail plate and position the clips proximate the rail plate;
a clip engagement component configured to engage a clip positioned proximate the rail plate; and
a screw connected to the electric-powered drill and the clip engagement component,
wherein when the screw is rotated by the electric-powered drill, the screw drives the clip engagement component forward, causing the clip to be inserted into the rail plate.

2. The clip insertion system of claim 1, wherein the drill is a battery-operated drill.

3. The clip insertion system of claim 2, wherein the drill includes a rechargeable battery configured to provide power to the portable device.

4. The clip insertion system of claim 1, wherein the clip comprises an E-clip type clip.

5. The clip insertion system of claim 4, wherein the clip placement chute includes one or more internal walls configured to receive the E-clip type clip and guide the E-clip type clip vertically down the chip placement chute.

6. The clip insertion system of claim 1, wherein the clip placement chute is configured to receive a cartridge of clips comprising the clip and sequentially feed individual clips of the cartridge of clips into a predefined position proximate the rail plate.

7. The clip insertion system of claim 1, the system further comprising a trigger connected to the electric-powered drill and configured to receive user input, wherein the screw is rotated by the electric-powered drill in response to the user input.

8. The clip insertion system of claim 1, wherein the clip insertion system is configured to roll from the rail tie to another rail without a user having to lift the clip insertion system.

9. The clip insertion system of claim 1, the system further comprising a handle assembly comprising a handle, one or more fastening straps to removably secure the electric-powered drill to the clip insertion system, and one or more side plates to connect the handle assembly to a body of the clip insertion system.
